(19) United States
(12) Patent Application Publication
(10) Pub. No.: US 2026/0370658 A1
(43) Pub. Date: Nov. 19, 2026

(54) METHODS FOR DETECTING A MALICIOUS DOMAIN NAME SERVER, CORRESPONDING EQUIPMENT, TRUSTED SERVER AND COMPUTER PROGRAM

(71) Applicant: Orange, Issy-Les-Moulineaux (FR)

(72) Inventors: Mohamed BOUCADAIR, Chatillon Cedex (FR); Christian JACQUENET, Chatillon Cedex (FR)

(21) Appl. No.: 19/135,722

(22) PCT Filed: Dec. 4, 2023
(86) PCT No.: PCT/EP2023/084041

§ 371 Date: Jun. 4, 2025

(30) Foreign Application Priority Data
Dec. 5, 2022 (FR) FR2212748

(51) Int. Cl. H04L 9/40

(52) U.S. Cl. CPC H04L 63/1416; H04L 63/1425

(57) ABSTRACT

A method for detecting a malicious DNS server, implemented in a piece of equipment configured with at least one trusted DNS server, the method including: transmitting, to at least one of the trusted servers, at least one request to activate a DNS verification service, receiving at least one response comprising at least one domain name generated by the trusted server, transmitting at least one request to resolve the at least one domain name, if no request to resolve the at least one domain name is received by the trusted server, or if at least one request is received but comprises an anomaly, receiving at least one notification requiring the piece of equipment to take an action.

### CROSS-REFERENCE TO RELATED APPLICATIONS

This application is filed under 35 U.S.C. § 371 as the U.S. National Phase of Application No. PCT/EP2023/084041 entitled “METHOD FOR DETECTING A MALICIOUS DOMAIN NAME SERVER, CORRESPONDING EQUIPMENT, TRUSTED SERVER AND COMPUTER PROGRAM” and filed Dec. 4, 2023, and which claims priority to FR2212748 filed Dec. 5, 2022, each of which is incorporated by reference in its entirety.

### BACKGROUND

### Field

The field of the development is that of communications within a communication network, for example a computer network implementing the IP protocol.

More specifically, the development relates to name resolution services, for example DNS (Domain Name System), and proposes a solution that contributes to detecting the presence of a malicious server involved in name resolution.

### Description of the Related Technology

The development of the Internet is based on a range of service offers for the consumer and business markets. Among these, multi-service offers, including “Triple Play” offers (proposing simultaneously an access to the Internet, video content (including television programme broadcasting) and conversational services (IP telephony)), have captured a significant share of the market.

One of the factors common to the operators' offers is the systematic presence of a home or business gateway, often referred to as CPE (Customer Premises Equipment), HG (Home Gateway) or box. Such a CPE is typically used as an interface between the local area network (LAN) of a user and the network of an operator with which the user has subscribed to a service offer (Internet Service Provider, ISP). It is therefore a piece of equipment for accessing the network of an operator, through which the traffic characteristic of the various services subscribed to by the user transits.

The CPE being a crossing point for the traffic from or to a user via an operator network, attacks can be carried out on this piece of equipment, for example to intercept sensitive data of the user, such as bank details.

By way of example, an attack consists in modifying the configuration of the DNS information stored in a CPE, descriptive of at least one trusted server associated with at least one network interface via which the CPE is capable of communicating.

As a reminder, a DNS service makes it possible to associate a resource (for example of type domain name, URI (Uniform Resource Identifier), etc.) with one or more IP addresses to access this resource. For example, the DNS service allows a terminal connected to the CPE to obtain the 1Pv4 and/or 1Pv6 addresses associated with a domain name. Thus, when a terminal connected to the CPE wants to reach an application server identified by a domain name, a DNS resolution request is relayed by the CPE to at least one of the trusted DNS servers configured in the CPE. A connection is then established between the terminal and the application server using the IP address(es) returned by the DNS server to the CPE.

If an attacker wants to capture the traffic of a user and intercept some of their data, they can, according to a first example, provide the user with an IP address of a malicious application server used by the attacker, instead of an IP address of the (legitimate) application server the user initially wanted to access. To do this, the attacker can modify the configuration of the DNS information stored in the CPE so that it relays the DNS requests sent by the terminal to a malicious DNS server managed by the attacker, instead of the trusted DNS server initially configured. All communications requiring DNS exchanges can thus be intercepted by the malicious DNS server. The attacker can then redirect the traffic of the user victim of the attack to fraudulent servers that will emulate certain sites (for example, servers used to complete a financial transaction).

According to a second example, the attacker can also decide to redirect the application requests sent by the user to a “legitimate” application server, to prevent the user from realising that they are the target of an attack. In this case, the attacker first directs the user's requests to a “fraudulent” application server by manipulating the DNS requests, and then to the “legitimate” application server. To do this, as in the first example, the attacker can modify the configuration of the DNS information stored in the CPE so that it relays the DNS requests sent by the terminal to a malicious DNS server managed by the attacker, instead of the trusted DNS server initially configured. However, in the second example, the fraudulent application server does not “emulate” the requested service but behaves as a relay (“proxy”) that terminates the security association with the user's terminal and relays the messages between this terminal and the legitimate application server. In doing so, the fraudulent application server accesses the content of the encrypted messages.

Protecting the access to the CPE administration interface (which is used notably to configure the DNS information in the CPE) with a password is not enough to protect the CPE from the attacks described previously. Indeed, as most users do not use (or are not even aware of the existence of) the CPE administration interface, the access to this administration interface is often poorly protected. Similarly, protecting the access to the CPE administration interface with a MAC (“Medium Access Control”) address may prove ineffective, as an attacker can change the MAC address of their terminal so it is identical to the one(s) authorised by the CPE. These MAC addresses can indeed be acquired maliciously by listening to the Wi-Fi exchanges, for example.

There is therefore a need for a new solution to detect a fraudulent modification of the DNS configuration information, and notably to maintain the security of the users' personal data.

### SUMMARY

The development proposes a solution for detecting a malicious domain name server, implemented in a piece of equipment configured with at least one trusted domain name server associated with at least one network interface via which said piece of equipment is capable of communicating.

Such a piece of equipment implements:
the transmission, to at least one of said trusted servers, of at least one request to activate a domain name resolution verification service,
the reception of at least one response comprising at least one domain name generated by said trusted server for said at least one interface,
the transmission of at least one request to resolve said at least one domain name,
if no request to resolve said at least one domain name is received by said trusted server, or if at least one request to resolve said at least one domain name is received by said trusted server but comprises an anomaly, the reception of at least one notification requiring said piece of equipment to take an action.

The proposed solution thus allows a piece of equipment (for example, a terminal, a CPE, etc.) to take an action if a trusted domain name server, configured for at least one network interface (for example, Ethernet, Wireless LAN, etc.) of the piece of equipment, detects an anomaly in a specific domain resolution request sent via an interface of the piece of equipment.

More specifically, according to the proposed solution, the trusted server can generate one or more specific domain names for at least one interface of the piece of equipment. For example, such a domain name, noted for example “TARGET_HB_FQDN”, can be generated randomly by the trusted server. It is therefore considered that such a domain name is unique and that the trusted server is identified as an authoritative server for the domain name thus generated. The trusted server can transmit to the piece of equipment the domain name(s) generated for at least one of its interfaces. Such domain names are therefore known only to the trusted server and the piece of equipment. The trusted server can then detect the presence of a malicious server if no request to resolve this or these domain names is received by it, or if one or more requests to resolve this or these domain names (referred to as “HB” for example in the following) are received but comprise an anomaly (for example, the source address of the request to resolve the domain name is not an address of the piece of equipment).

In this case, a notification is sent by the trusted server to the piece of equipment, so that the piece of equipment can take at least one action, for example, correct the active domain name resolution configuration. Such an action can thus be executed automatically by the piece of equipment, without any intervention of a user. As a result, even though the user would have no technical knowledge of computer systems, the DNS configuration information of the piece of equipment can be reset, or the traffic to or from a malicious application server can be stopped.

The proposed solution thus contributes to improving the robustness of the value-added IP services (DNS services included) and to protecting the user from attacks that would be based on a name resolution service such as the DNS service.

In addition, the proposed solution does not require any traffic inspection in the network (for example, in the access network) or any profiling of communications to detect anomalies. The solution can thus be implemented independently of the underlying connectivity offer.

It should be noted that a piece of equipment according to the development can embed one or more “DNS clients”. In other words, a DNS client can be supported by the operating system (OS) of a piece of equipment, or be specific to an application. In the latter case, several DNS clients can be activated on the same piece of equipment, each of these clients being identified in a univocal manner. The method according to the development can be implemented by one of these DNS clients or be supported by a dedicated application. Notably, each DNS client of a piece of equipment can implement the steps described above. The development makes no assumptions about the internal interface used between an application and a name resolution function (typically a DNS client).

According to a particular embodiment, said at least one response also comprises verification data (noted for example “CHALLENGE”) generated by said trusted server for said at least one activation request. Said at least one request to resolve said at least one domain name generated by the piece of equipment then comprises a proof of integrity obtained from said verification data.

Upon receipt of a resolution request by the trusted server, the latter can thus check the integrity of the resolution request thanks to the proof of integrity, which contributes to improving the security of the proposed solution. For example, the proof of integrity is a hash of said verification data.

In a particular embodiment, said at least one request to resolve said at least one domain name comprises an indicator requiring the generation, by said trusted server, of new verification data.

Such a change in the verification data contributes to strengthening the security of the proposed solution.

The piece of equipment can then initiate a change in the verification data. As described hereafter with the description of a particular embodiment, the piece of equipment sends for example a resolution request noted “HB (C, NONCE1)”.

As a variant, the server can initiate a change in the verification data. Such a change in the verification data can notably be implemented on a regular basis or according to other policies local to the name resolution server.

In particular, said at least one response and/or said resolution request can be encrypted.

Such an encryption makes it possible to preserve the verification data transmitted in the response to the activation request (i.e. response from the trusted server to the piece of equipment) or the proof of integrity transmitted in the “HB” resolution request.

In a particular embodiment, said at least one response also comprises a piece of recurrence information (noted for example “EPOCH”). Said at least one request to resolve said at least one domain name is transmitted taking into account said piece of recurrence information.

For example, the piece of recurrence information provides for the periodicity at which resolution requests (“HB”) are sent by the piece of equipment, the sending of a resolution request when the piece of equipment is restarted, when connecting to a new network, etc.

In a particular embodiment, said at least one activation request comprises at least one contact address of said piece of equipment (noted for example “CONTACT_URI”).

In this way, the trusted server can send the piece of equipment a notification to this contact address to inform the piece of equipment of an anomaly or anomalies observed in the domain name resolution. It is assumed that the piece of equipment establishes the appropriate procedures to be able to receive these messages (for example, configuration of a firewall, NAT). These procedures are known per se and are therefore not repeated here. An example is notably described in document RFC6887 “Port Control Protocol (PCP)” of April 2013.

According to a particular embodiment, the information descriptive of said at least one trusted server is stored in a registry maintained by said piece of equipment and whose access is protected. It is recalled that it is conventional to configure at least one list of at least one trusted server associated with at least one interface of a piece of equipment. According to the development, such configuration information (i.e. information descriptive of said at least one trusted server) is stored in a specific registry, whose access is protected, for example with a password or verification keys. In this way, an attacker does not have direct access to this configuration information, which contributes to strengthening the security of the proposed solution.

In particular, the registry whose access is protected is distinct from any other registry used to store other information relating to the resolution of domain names.

Notably, the location of this protected registry is not predefined, and may be different for various pieces of equipment. The location of the registry can notably be chosen randomly when activating the domain name resolution verification service.

According to a particular embodiment, the piece of equipment being configured to execute at least one action, said piece of equipment executes at least one given action (for example, preconfigured) upon receipt of a notification requiring it to execute said at least one action. For example, said at least one action belongs to the group comprising:
replace the active domain name resolution configuration with the configuration of one of said trusted servers,
disable outgoing communications except for communications to one of said trusted servers,
generate a local notification to inform a user of a modification of the domain name resolution configuration,
request that the active domain name resolution configuration be sent.

Notably, such actions may have been previously configured for the piece of equipment. Thus, upon receipt of a notification, the piece of equipment knows the action it must execute. The proposed solution therefore does not involve the user in resolving the anomalies. The user is therefore not expected to have any particular technical knowledge for implementing the development.

The development also relates to such a method for detecting a malicious domain name server, implemented in the trusted server. Such a trusted server implements the following steps:
receiving at least one request to activate a domain name resolution verification service from said piece of equipment,
transmitting at least one response comprising at least one domain name generated by said trusted server for said at least one interface,
if no request to resolve said at least one domain name is received by said trusted server, or if at least one request to resolve said at least one domain name is received by said trusted server but comprises an anomaly, transmitting to said piece of equipment at least one notification requiring it to execute an action.

As already indicated, the trusted server can generate one or more specific domain names for at least one interface of the piece of equipment and detect a problem in the domain name resolution verification service if no request to resolve the specific domain name is received, or if a request to resolve the specific domain name is received but comprises an anomaly. If a problem is detected, the trusted server can send a notification to at least one contact address of said piece of equipment carried by said activation request or to the address used by said piece of equipment to transmit said activation request. These verifications are made possible by the fact that the trusted server is authoritative for the domain names generated for at least one interface of a piece of equipment.

According to a particular embodiment, an anomaly is detected if said at least one request to resolve said at least one domain name and said at least one activation request do not come from the same piece of equipment.

For example, the trusted server compares the addresses used to send the activation request and to send the request to resolve said at least one domain name. If they differ or are not associated with the same piece of equipment, the trust server detects an anomaly.

According to a particular embodiment, said at least one response also comprises verification data generated by said trusted server for said at least one activation request. In this case, said at least one request to resolve said at least one domain name comprises a proof of integrity obtained from said verification data, and an anomaly is detected if said proof of integrity carried by said at least one request to resolve said at least one domain name is not consistent with a proof of integrity obtained from the verification data known to the trusted server.

For example, the trusted server generates verification data randomly and transmits it in its response. The piece of equipment computes a hash of this verification data and transmits it in the request to resolve the specific domain name. Upon receipt, the trusted server can compute locally a hash of the verification data it knows, and compare it with the hash received in the resolution request.

According to a particular embodiment, said at least one response comprises new verification data generated by said trusted server for said piece of equipment, at the initiative of said trusted server or upon receipt of a request from said piece of equipment.

As mentioned previously, the verification data can effectively be renewed at the initiative of the piece of equipment or the trusted server, for example on a regular basis, so as to improve the security of the proposed solution.

According to a particular embodiment, said at least one response also comprises a piece of recurrence information (noted for example “EPOCH”) of said at least one request to resolve said at least one domain name, and an anomaly is detected if no request to resolve said at least one domain name is received by said trusted server or if said at least one request to resolve said at least one domain name is not consistent with said piece of recurrence information.

Again, the use of such a piece of information contributes to strengthening the security of the proposed solution.

According to a particular embodiment, said activation requests and/or requests to resolve said at least one domain name use an option according to the DNS mechanism as described in document RFC 6891 (“Extension Mechanisms for DNS” (EDNS) of April 2013) to transmit various information between the piece of equipment and the trusted server (for example, a domain name (“TARGET_HB_FQDN”), verification data (“CHALLENGE”), recurrence information (“EPOCH”), a contact address (“CONTACT_URI”), etc.).

In another embodiment, the development relates to a corresponding piece of equipment. Such a piece of equipment is notably suitable for implementing a method for detecting a malicious domain name server according to at least one embodiment of the development. Thus, such a piece of equipment can comprise the various characteristics relating to a method according to the development, which may be combined or taken separately. For example, the piece of equipment is of type CPE, terminal, etc. The piece of equipment can be connected to a fixed network, a mobile network, a network of connected objects (for example, a mesh network according to the “Thread” protocol), etc.

In another embodiment, the development relates to a corresponding trusted server. Such a trusted server is notably suitable for implementing a method for detecting a malicious domain name server according to at least one embodiment of the development. Thus, such a server can comprise the various characteristics relating to the method according to the development, which may be combined or taken separately.

In yet another embodiment, the development relates to one or more computer programs comprising instructions for implementing a method for detecting a malicious domain name server according to at least one embodiment of the development, when this or these programs are executed by a processor.

The methods according to the development can therefore be implemented in various ways, notably in wired form and/or in software form.

In particular, the method according to the development can be implemented by a generic module, an application, etc.

### BRIEF DESCRIPTION OF THE DRAWINGS

Other characteristics and advantages of the development will emerge more clearly upon reading the following description of a particular embodiment, provided as a simple illustrative non-restrictive example, and the annexed drawings, wherein:

FIG. 1 illustrates the main steps of a method for detecting a malicious domain name server according to one embodiment,

FIG. 2 shows the generic format of a WADE option according to one embodiment,

FIG. 3 shows a WADE option example according to one embodiment,

FIG. 4 illustrates an example of messages exchanged between a DNS client and a trusted server without any anomalies being detected,

FIG. 5 illustrates an example of messages exchanged between a DNS client and a trusted server with the modification of the verification data at the initiative of the DNS client,

FIG. 6 illustrates an example of messages exchanged between a DNS client and a trusted server with the modification of the verification data at the initiative of the trusted server,

FIG. 7 illustrates an example of messages exchanged between a DNS client and a trusted server with the detection of a non-compliance with the piece of recurrence information anomaly,

FIG. 8 illustrates an example of messages exchanged between a DNS client and a trusted server with the detection of an anomaly related to the source address,

FIG. 9 illustrates an example of messages exchanged between a DNS client and a trusted server for the deactivation of a domain name resolution verification service, and

FIG. 10 shows the simplified structure of a piece of equipment, respectively a trusted server, according to one embodiment.

### DETAILED DESCRIPTION OF CERTAIN ILLUSTRATIVE EMBODIMENTS

### General Principle

The context is that of a piece of equipment (for example, a terminal, a CPE) configured with information descriptive of at least one trusted domain name server associated with a network interface via which the piece of equipment is capable of communicating.

The general principle of the development is based on the generation, by the trusted server, of at least one specific domain name for at least one interface of the piece of equipment and the establishment of a procedure for sending resolution requests related to this specific domain name. The trusted server can thus detect a problem in a domain name resolution service if it does not receive any request to resolve the specific domain name, or if a request to resolve the specific domain name it receives comprises an anomaly. The trusted server can then inform the piece of equipment, which can then take appropriate actions.

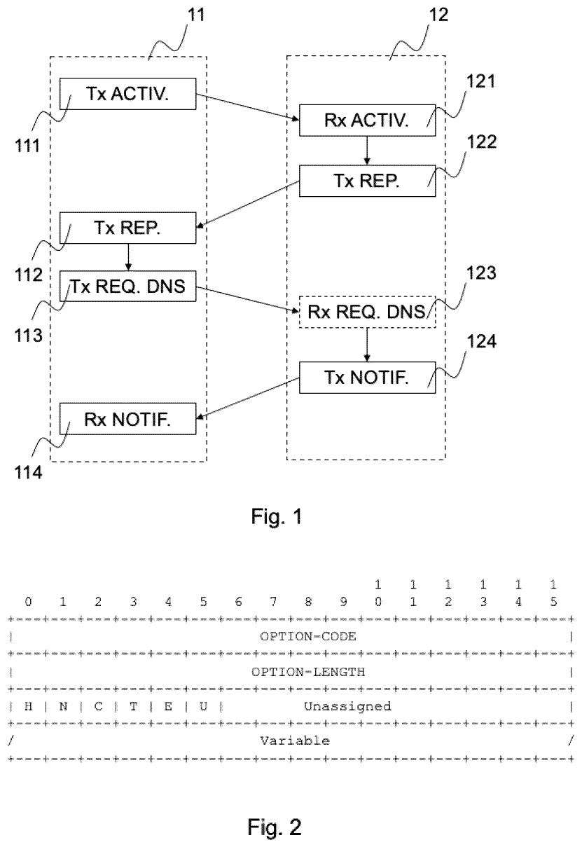

In relation to FIG. 1, the main steps implemented for detecting a malicious domain name server according to the development are presented.

A piece of equipment H 11 configured with at least one trusted domain name server DNS 12 associated with at least one network interface via which the piece of equipment is capable of communicating is considered.

During a first step 111, the piece of equipment 11 transmits to the trusted server 12, via at least one network interface, at least one request ACTIV to activate a domain name resolution verification service. The trusted server 12 receives said at least one activation request ACTIV during a step 121.

The activation request can notably be a dedicated request, such as a DNS request reserved for activating the domain name resolution verification service. An example of such a dedicated request is a request to resolve a dedicated domain name, capable of triggering the activation of the verification service. This dedicated domain name can be a name configured when subscribing to the service (for example, “peraspera.example”) or a domain name reserved for this use and that can be used by all operators (for example, “peraspera. arpa”).

As a variant, the activation request can be a “non-dedicated” request. In this case, the piece of equipment does not generate a DNS request relating to a domain name dedicated to activating the domain name resolution verification service, but uses a conventional DNS request, for example a DNS request sent for the purposes of an application embedded in the piece of equipment, and inserts into it information for activating the domain name resolution service. A conventional DNS request is thus diverted by inserting into it particular information, for example in the form of a new option according to a DNS extension mechanism as described below.

The trusted server 12 can generate at least one specific domain name for the network interface used, and transmit to the piece of equipment 11 at least one response comprising the specific domain name(s), during a step 122. It is therefore considered that such a domain name is unique and that the trusted server is authoritative for the domain name thus generated. According to the example illustrated by FIG. 1, the trusted server transmits a single response REP carrying a unique domain name. The piece of equipment 11 receives the response REP during a step 112.

The piece of equipment 11 can then transmit to the trusted server 12 at least one request to resolve the unique domain name REQ DNS during a step 113. Such a resolution request relating to the unique domain name is also referred to as HB (“Heartbeat”) hereafter.

If the trusted server 12 receives a request REQ DNS during a step 123, but this request REQ DNS comprises an anomaly, the trusted server 12 sends a notification NOTIF to the piece of equipment 11 during a step 124, requiring it to execute an action.

If the trusted server 12 does not receive any request REQ DNS related to the unique domain name communicated to the piece of equipment 11 when activating the procedure (steps 122/112), the trusted server 12 sends a notification NOTIF to the piece of equipment 11 requiring it to execute an action, for example after a waiting period. The waiting period can notably be predefined, configured in the trusted server, known to the piece of equipment or transmitted to the piece of equipment, etc.

The piece of equipment 11 can thus receive, during a step 114, a notification NOTIF requiring it to execute an action, for example a predefined action. The piece of equipment can then execute such an action, without requiring any interaction with a user of the piece of equipment or an administrator of a local area network (for example, administrator of a home network, administrator of a CPE).

As described hereafter, different information can be used by the trusted server to detect an anomaly during the processing of a domain name resolution request.

Notably, verification data and/or a piece of recurrence information can be transmitted in the response REP from the trusted server to the piece of equipment, and used by the piece of equipment to manage the transmission of the request to resolve the unique domain name REQ DNS to the trusted server. An anomaly can notably be detected if the activation request ACTIV and the request to resolve the unique domain name REQ DNS do not come from the same piece of equipment, or if a proof of integrity, obtained from the verification data and conveyed by the request REQ DNS, is not consistent with a proof of integrity obtained from the verification data known to and maintained locally by the trusted server, or if the sending of the request(s) REQ DNS does not comply with the piece of recurrence information, or if the request REQ DNS includes a piece of information of a DNS relay, for example.

### DETAILED DESCRIPTION OF A PARTICULAR EMBODIMENT

### Initial Configuration

A detailed embodiment of the development is described below. It is considered that a user of the piece of equipment (for example, a terminal) wants to activate a domain name resolution verification service. Hereinafter, such a service is referred to as “PER ASPERA” (“PER-DNS client guards Against malicious DNS Server swaPping, traffic intERception, and datA theft”).

For example, the user can subscribe to the PER ASPERA service using a dedicated interface. The PER ASPERA service can notably be provided to terminals directly connected to the network of a service provider or reserved for offers based on the provision of a CPE. As already indicated, a “piece of equipment” is a terminal or a CPE used by a user wanting to take advantage of the PER ASPERA service. It should be noted that the PER ASPERA service can be proposed by a connectivity service provider, a DNS service provider, etc. notably, a user can call upon a DNS service provider distinct from the provider providing them connectivity.

The piece of equipment of the user can connect to several networks using the same piece of access equipment or different pieces of equipment. The piece of equipment of the user can use the same DNS service for all the access networks (fixed and mobile) to which it can connect. The PER ASPERA service can be proposed independently of the nature of the access network(s) used by the piece of equipment of the user. In addition, the PER ASPERA server may be used for some of the interfaces only.

Conventionally, the piece of equipment, or at least one network interface of the piece of equipment, is configured with at least one list of at least one trusted DNS server. In order to improve the security of the proposed solution, the connections between the piece of equipment and the trusted server(s) are, in the embodiment described here, secure. Thus, the trusted server(s) can support at least one encryption scheme based, for example, on the use of one or other of the following protocols: DNS overTLS (DoT), DNS over DTLS (DoD), DNS over HTTPS (DoH), DNS over QUIC (DoQ), DNS over CoAP (DoC), etc.

The list(s) of at least one trusted server can be configured using a mechanism based on a discovery of neighbour-designated resolvers (DNR), as described in document “DHCP and Router Advertisement Options for the Discovery of Network-designated Resolvers (DNR)” of August 2022, a mechanism based on a key exchange (IKE, “Internet Key Exchange”, as described in document “Internet Key Exchange Protocol Version 2 (IKEv2) Configuration for Encrypted DNS” of September 2022), etc. If the piece of equipment has several network interfaces, at least one list of at least one trusted server can be configured through a network interface (wired, wireless, 5G, etc.). In this case, a list of at least one trusted server can be associated with an identifier of the network interface concerned.

According to a particular embodiment, the piece of equipment can also be configured with at least one action. For example, the piece of equipment is configured with an indexed list of predefined actions. Such a list may contain (non-exhaustively) the following actions:
policy/action index “0”: replace the active domain name resolution configuration with the configuration of one of the trusted servers,
policy/action index “1”: disable outgoing communications except for communications to one of the trusted servers for a given interface,
policy/action index “2”: generate a local notification to inform the user of a modification of the domain name resolution configuration,
policy/action index “3”: request that the active domain name resolution configuration be sent,
etc.

According to a particular embodiment, the information descriptive of the trusted server(s) (i.e. the configuration of the list(s) of at least one trusted server) is stored in a registry maintained by the piece of equipment and whose access is protected. The access to this registry can notably implement strong authentication mechanisms (for example, using a dedicated password or multi-level verification keys). The location of such a registry can notably be decided when activating the PER ASPERA service. The registry can correspond to dedicated entries in a Windows@ registry, a file, a database, etc.

In particular, such a registry is distinct from any other registry used to store other information relating to the resolution of domain names. The registry storing the list(s) of at least one trusted server is therefore isolated from the other registries used to store the information used for DNS management.

Possibly, the information descriptive of the trusted server(s) can be duplicated to be, on the one hand, stored in the registry whose access is protected, on the other hand, in a registry conventionally used to store information relating to the resolution of domain names.

The purpose of this isolation is to prevent the list of trusted DNS servers from being modified by a malicious application or following fraudulent access to the piece of equipment.

In concrete terms, an application that accesses the local DNS configuration without the user's consent may be able to modify the active DNS configuration, but cannot modify the trusted server configuration stored in the registry whose access is protected.

### Activating the Per Aspera Service

Hereinafter, the term “DNS client” is used to designate the piece of equipment or at least one network interface of the piece of equipment implementing the proposed solution.

As described in FIG. 1, during a first step 111, a DNS client transmits to at least one of its trusted servers at least one DNS request to activate the PER ASPERA service. As already indicated, this activation request can be dedicated to the activation of the domain name resolution verification service. In this case, the activation request is a DNS request reserved for the PER ASPERA service. As a variant, the activation request can be non-dedicated, notably when conventional requests are used for the purposes of the usage applications. In this case, the DNS client uses a request sent, for example, by an application embedded in the piece of equipment, inserting the information required to activate the PER ASPERA service.

It should be noted that if the same trusted server is associated with several interfaces of the piece of equipment, one activation request can be sent per interface; each of these requests is routed to the trusted server via the relevant interface. Indeed, sending these various requests via an interface makes it possible to communicate to a trusted server the external address of the piece of equipment (DNS client) that makes it reachable via this interface.

If several lists of trusted servers are configured, then an activation request is sent to each of these lists, i.e. to at least one trusted server of each of the lists. This makes it possible in particular to control the DNS activity for all the interfaces of a piece of equipment when they are associated with different trusted servers.

According to one embodiment of the development, the activation request(s) use(s) a new option according to the EDNS mechanism. Such an option is referred to hereafter as WADE (“An EDNS Option for WAtching DNS associations to prevent swapping, interception, and theft”). An extended request according to the EDNS mechanism is identified thanks to an OPT pseudo resource-record (RR).

The generic format of the WADE option is illustrated in FIG. 2.

As illustrated by FIG. 2, the “OPTION-DATA” data field of the OPT RR provides for six control indicators, for example in the form of 6 bits H, N, C, T, E, U:
the H bit, also referred to as “HB_ENABLE” (Heartbeat Enable), set to the value “1” indicates a request to activate the PER ASPERA service, while the value “0” is used to deactivate the PER ASPERA service,
the N bit set to the value “1” indicates the presence of the “NONCE” field,
the C bit set to the value “1” indicates the presence of the “CHALLENGE” field,
the T bit set to the value “1” indicates the presence of the “TARGET_HB_FQDN” field,
the E bit set to the value “1” indicates the presence of the “EPOCH” field,
the U bit set to the value “1” indicates the presence of the “CONTACT_URI” field.

These various fields (“NONCE”, “CHALLENGE”, “TARGET_HB_FQDN”, “EPOCH”, “CONTACT_URI”) are presented hereafter. In particular, the “CHALLENGE”, “TARGET_HB_FQDN” and “EPOCH” fields are filled in by a trusted server.

When several of these fields are carried in the same WADE option, then these various fields are inserted in the order of the check bits. Variable parameters are preceded by a field indicating the size of the parameter.

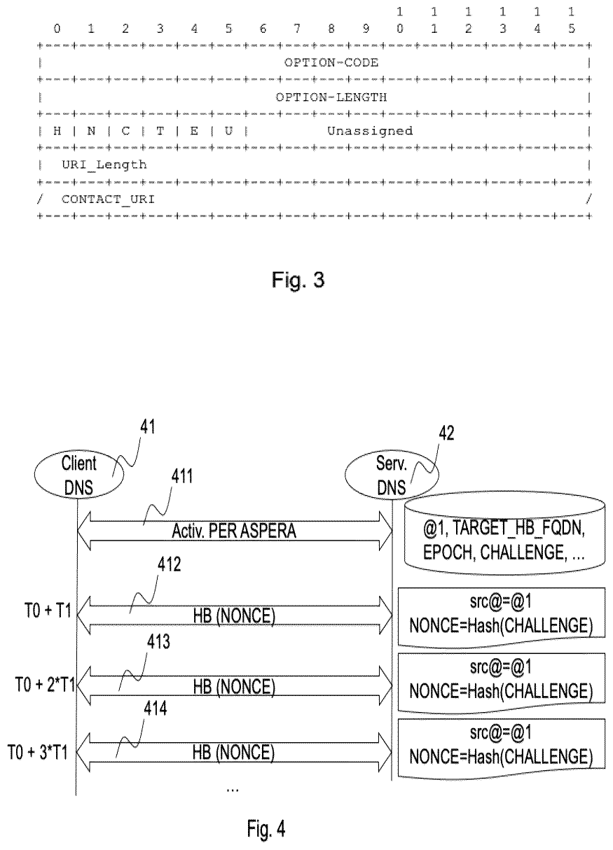

An activation request including the WADE option, as illustrated by FIG. 3, uses the H bit and optionally the U bit, set to the value “1”. The other bits (N, C, T and E) can be set to the value “0”.

Thus, the H bit can take a value “1” to indicate a request to activate the PER ASPERA service. The “U” bit can also take a value “1” to indicate the presence of the “CONTACT_URI” field. A “URI_Length” field can notably be provided for to indicate the size of the parameter present in the “CONTACT_URI” field, as illustrated by FIG. 3.

Such a “CONTACT_URI” field can be present in a request to activate the PER ASPERA service. This field lists the contact identifier(s) that the trusted server (which receives the activation request) can use to report anomalies observed in the DNS configuration information (for example, by transmitting to the DNS client a notification requiring it to take an action).

If the U bit is set to the value “1”, i.e. if the “CONTACT_URI” field is present, this means that the contact address(es) for sending the notifications are those entered in the “CONTACT_URI” field.

If the U bit is set to the value “0”, i.e. if the “CONTACT_URI” field is not present, this means that the contact address for sending the notifications is the address (as well as the port number) used by the DNS client to send this activation request.

It should be noted that the PER ASPERA service can be deactivated at any time by a piece of equipment. To do this, a request that contains the WADE option can be sent from the DNS client to a trusted server, using the H bit set to the value “0”. In the following, it is assumed that the service is activated.

It should be noted that such a WADE option is only inserted into a DNS request intended for a trusted server. This verification is based, for example, on the destination IP address of the DNS request or the ADN (Authentication Domain Name) of the target DNS server.

### Response From the Trusted Server

As indicated in relation to FIG. 1, at least one trusted server receives at least one request to activate the PER ASPERA service during a step 121.

If a trusted server does not support the WADE option, then it can respond with an error message. The DNS client can possibly select another trusted server configured in its list, send an activation request to the same server but without the WADE option, terminate the communication and generate a local notification (application, user, etc.), etc.

If a trusted server supports the WADE option, then it can process the activation request received. Notably, the trusted server can extract the information communicated in the WADE option, notably in the “CONTACT_URI” field where applicable. For example, the trusted server can extract a source IP address and port number from the activation request. This information can be stored for later use. A trusted server can thus maintain one or more source addresses per DNS client.

The trusted server can notably prepare at least one response and transmit it to the DNS client during the step 122 of FIG. 1. Such a response can notably take the form of a DNS request that includes the WADE option as illustrated by FIG. 2.

In particular, such a response including the WADE option uses the H and T bits, and possibly the C and E bits, set to the value “1”. The other bits (U, N) can be set to the value “0”. Thus, the H bit can be set to “1” to indicate the acceptance of a request to activate the PER ASPERA service.

The “U” bit can also be set to “1” to indicate the presence of the “TARGET_HB_FQDN” field. A “TARGET_HB_FQDN_Length” field can notably be provided for to indicate the size of the parameter present in the “TARGET_HB_FQDN” field.

Such a “TARGET_HB_FQDN” field comprises one or more specific domain names generated by the trusted server for the DNS client considered. The trusted server is authoritative for these domain names. They are therefore considered as unique, and known only to the DNS client and the trusted server. To do this, they are generated randomly, for example.

Possibly, the C bit can take a value “1” to indicate the presence of a “CHALLENGE” field. A “CHALLENGE_Length” field can notably be provided for to indicate the size of the parameter present in the “CHALLENGE” field.

Such a “CHALLENGE” field comprises verification data that can be used by the DNS client to determine a proof of integrity. For example, such verification data can be generated randomly and used by the DNS client to compute a proof of integrity, such as a hash. Such a proof of integrity can then be inserted by the DNS client into the subsequent DNS requests intended for the trusted server.

Possibly, the E bit can take a value “1” to indicate the presence of an “EPOCH” field. An “EPOCH_Length” field can notably be provided for to indicate the size of the parameter present in the “EPOCH” field.

Such an “EPOCH” field comprises a piece of recurrence information, used by the DNS client to transmit the “HB” requests to resolve domain names. For example, such a field indicates the periodicity of the HB requests from the DNS client.

If the “EPOCH” and “CHALLENGE” fields are activated, C, T, E bits are set to the value “1” and U and N bits are set to the value “0”.

In particular, the trusted server can store the information communicated to each DNS client.

In a particular embodiment, the trusted server can control the TTL (“Time To Live”) field of the responses to force the DNS client to renew the activation of the PER ASPERA service by returning an activation request.

### Request to Resolve the Domain Name of the TARGET_hb_FQDN Field

As indicated in relation to FIG. 1, the DNS client receives a response from the trusted server during a step 112.

The DNS client can extract the information contained in the WADE option, notably in the “TARGET_HB_FQDN” field. If information is present in the “EPOCH” and/or “CHALLENGE” fields, this information can also be extracted. The DNS client can store this information, in association with at least one trusted server and at least one interface. Several responses that contain the WADE option can be sent to the DNS client by a trusted server. All this information can be stored by the DNS client in an appropriate registry, whose access can be protected.

As illustrated by FIG. 1, the DNS client can then send a request to resolve the domain name present in the “TARGET_HB_FQDN” field during a step 113. Such a request can notably take the form of a DNS request with the WADE option as illustrated by FIG. 2. In particular, such a request that contains the WADE option can use the H and N bits set to the value “1”. The other bits (C, T, E and U) can be set to the value “0”.

The N bit can be set to “1” to indicate the presence of the “NONCE” field. A “NONCE_Length” field can notably be provided for to indicate the size of the parameter present in the “NONCE” field.

Such a “NONCE” field comprises, for example, a proof of integrity generated from the verification data transmitted in the “CHALLENGE” field.

FIG. 4 illustrates an example of messages exchanged between a DNS client 41 and a trusted DNS server 42.

By way of example, it is considered that the DNS client 41 sends an activation request using its address @1 as the source address, and that the trusted server 42 constructs a response comprising the “TARGET_HB_FQDN”, “EPOCH” and “CHALLENGE” fields. At the end of these steps of receiving at least one activation request and constructing at least one response (noted Activ. PER APSERA 411), the trusted server 42 has the information contained in the “TARGET_HB_FQDN”, “EPOCH” and “CHALLENGE” fields, and the source address of the activation request (@1).

According to the example considered, the DNS client 41 can notably send one or more DNS requests to resolve the domain name indicated in the “TARGET_HB_FQDN” field, noted HB, taking into account the value indicated in the “EPOCH” field of the response received. For example, the “EPOCH” comprises a piece of recurrence information indicating a sending periodicity T1 of the HB requests. Thus, a first HB request to resolve the domain name indicated in the “TARGET_HB_FQDN” field can be sent at time T0+T1, a second HB request to resolve the domain name indicated in the “TARGET_HB_FQDN” field can be sent at time T0+2*T1, a third HB request resolve the domain name indicated in the “TARGET_HB_FQDN” field can be sent at time T0+3*T1, etc.

Such HB (“HeartBeat”) requests signal to the trusted server 42 the presence of an active association with a DNS client 41.

According to the example considered, the DNS client 41 can notably compute a hash of the verification data conveyed in the “CHALLENGE” field of the response received during the PER ASPERA activation phase. Such a hash can notably be inserted into the “NONCE” field of the HB request that contains the WADE option.

According to the example illustrated by FIG. 4, the DNS client 41 sends a first HB request (412) to resolve the domain name indicated in the “TARGET_HB_FQDN” field, comprising a proof of integrity in the “NONCE” field, at time T0+T1. Upon receipt of the first HB request (412), the trusted server 42 can notably check that the source address of the activation request (@1) and the source address of the first HB request (src@) are consistent, i.e. identify the same piece of equipment (src@=@1). If this is not the case, an anomaly is detected. The trusted server 42 can also check that the proof of integrity contained in the “NONCE” field of the HB request is consistent with a proof of integrity determined locally from the verification data stored by the trusted server 42 (as recorded in the “CHALLENGE” field in the response sent by the trusted server). Notably, the trusted server 42 can compute a hash of the verification data (for example, perform the “Hash (CHALLENGE)” computation, where Hash designates a hash function corresponding to the one applied by the DNS client 41 to generate the hash of the verification data (for example “Secure Hash Algorithms (SHAs)” described in document RFC 6234 “US Secure Hash Algorithms (SHA and SHA based HMAC and HKDF)” of May 2011) and check that it is equal to the hash transmitted in the “NONCE” field. If this is not the case, an anomaly is detected by the trusted server 42. The trusted server 42 can also check whether the piece of recurrence information specified in the “EPOCH” field is respected. If this is not the case, an anomaly is detected. As a variant, the indication of the “hash” function to be used by a DNS client can be communicated using the WADE option. To do this, an “I” bit is defined to this end among the “unassigned” bits described in FIG. 2.

When the “I” bit is set to “1”, the identity of the “hash” function is entered in the body of the WADE option (for example, SHA2-256).

The DNS client 41 can then send a second HB request (413) to resolve the domain name indicated in the TARGET_HB_FQDN field, comprising a proof of integrity in the NONCE field, at time T0+2T1. The trusted server 42 can notably check that the source address of the activation request (@1) and the source address of the second HB request (src@) are consistent (src@=@1), that the verification data hash (Hash (CHALLENGE)) is equal to the hash transmitted in the NONCE field and that the piece of recurrence information contained in the “EPOCH” field is respected.

The DNS client 41 can send a third HB request (414) and so on.

In the example illustrated by FIG. 4, no anomaly is detected.

In a particular embodiment, the information communicated when activating the PER ASPERA service can be modified at the initiative of the trusted server 42 or the DNS client 41.

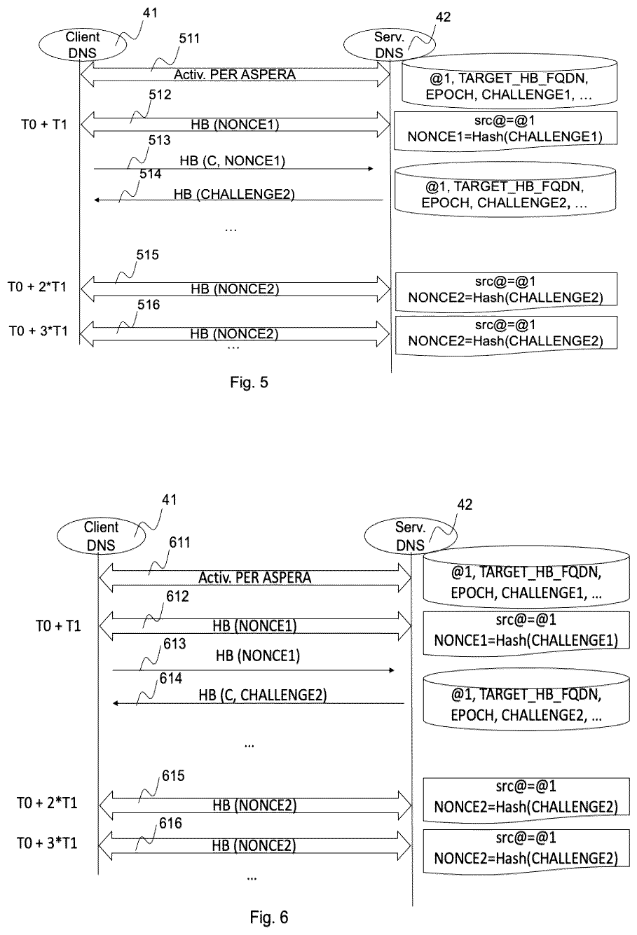

FIG. 5 illustrates an example of messages exchanged between the DNS client 41 and the trusted server 42, with a request to modify the verification data at the initiative of the DNS client 41.

It is considered for example that the DNS client 41 sends an activation request using its address @1, and that the trusted server 42 constructs a response comprising the “TARGET_HB_FQDN”, “EPOCH” and “CHALLENGE1” fields (Activ. PER APSERA 511).

According to the example illustrated by FIG. 5, the DNS client 41 sends a first HB request (512) to resolve the domain name indicated in the “TARGET_HB_FQDN” field, comprising a proof of integrity in the “NONCE1” field, at time T0+T1. Upon receipt of the first HB request (512), the trusted server 42 can notably check that the source address of the activation request (@1) and the source address of the first HB request (src@) are consistent. The trusted server 42 can also check that the proof of integrity contained in the “NONCE1” field of the HB request is consistent with a proof of integrity determined locally from the verification data carried by the “CHALLENGE1” field. Notably, the trusted server 42 can compute a hash of the verification data (Hash (CHALLENGE1)) and check that it is equal to the hash transmitted in the “NONCE1” field. The trusted server 42 can also check whether the piece of recurrence information specified in the “EPOCH” field is respected.

The DNS client 41 can ask at any time to modify the verification data (“CHALLENGE1”). To do this, the DNS client can send a second HB request (513) to resolve the domain name indicated in the “TARGET_HB_FQDN” field comprising a proof of integrity in the “NONCE1” field, computed on the basis of the verification data of the “CHALLENGE1” field. To inform the trusted server 42 that the DNS client 41 is requesting new verification data, C and N bits are set to “1”.

Upon receipt of this message, the trusted server 42 can accept the request and generate new verification data, that is sent to the DNS client 41 in a response that contains the WADE option in the “CHALLENGE2” field (514).

The DNS client 41 sends a third HB request (515) to resolve the domain name indicated in the “TARGET_HB_FQDN” field, comprising a proof of integrity in the “NONCE2” field, at time TO+2T1. Such a proof of integrity is obtained from the new “CHALLENGE2” verification data. Upon receipt of the third HB request (515), the trusted server 42 can notably check that the source address of the activation request (@1) and the source address of the third HB request (src@) are consistent, i.e. identify the same piece of equipment (src@=@1). The trusted server 42 can also check that the proof of integrity contained in the “NONCE2” field of the HB request is consistent with a proof of integrity determined locally from the verification data stored by the trusted server 42 (as contained in the “CHALLENGE2” field of the response sent by the trusted server). Notably, the trusted server 42 can compute a hash of the verification data (Hash (CHALLENGE2)) and check that it is equal to the hash contained in the “NONCE2” field. The trusted server 42 can also check whether the piece of recurrence information contained in the “EPOCH” field is respected.

The DNS client 41 can send a fourth HB request (516) and so on.

FIG. 6 illustrates an example of messages exchanged between the DNS client 41 and the trusted server 42, with a request to modify the verification data at the initiative of the trusted server 42.

It is considered for example that the DNS client 41 sends an activation request using its address @1, and that the trusted server 42 constructs a response comprising the “TARGET_HB_FQDN”, “EPOCH” and “CHALLENGE1” fields (Activ. PER APSERA 611).

According to the example illustrated by FIG. 6, the DNS client 41 sends a first HB request (612) to resolve the domain name indicated in the “TARGET_HB_FQDN” field, comprising a proof of integrity in the “NONCE1″ field, at time TO+T1. Upon receipt of the first HB request (612), the trusted server 42 can notably check that the source address of the activation request (@1) and the source address of the first HB request (src@) are consistent. The trusted server 42 can also check that the proof of integrity specified in the “NONCE 1″ field of the HB request is consistent with a proof of integrity determined from the verification data recorded in the ”CHALLENGE1” field. Notably, the trusted server 42 can compute a hash of the verification data (Hash (CHALLENGE1)) and check that it is equal to the hash recorded in the “NONCE1” field. The trusted server 42 can also check whether the piece of recurrence information contained in the “EPOCH” field is respected.

The trusted server 42 can decide at any time to modify the verification data (“CHALLENGE1”).

For example, upon receipt of a second HB request (613) to resolve the domain name indicated in the “TARGET_HB_FQDN” field comprising a proof of integrity recorded in the “NONCE1” field, computed on the basis of the verification data of the “CHALLENGE1” field, the trusted server 42 can generate new verification data. The trusted server 42 can transmit the new verification data to the DNS client 41 in a response that contains the WADE option recorded in the “CHALLENGE2” field (614). To inform the DNS client 41 that the trusted server 42 has generated new verification data that is transmitted in the “CHALLENGE2” field, the C bit is set to “1”.

The DNS client 41 can send a third HB request (615) to resolve the domain name indicated in the “TARGET_HB_FQDN” field, comprising a proof of integrity contained in the “NONCE2” field, at time T0+2T1. Such a proof of integrity is obtained from the new “CHALLENGE2” verification data. Upon receipt of the third HB request (615), the trusted server 42 can notably check that the source address of the activation request (@1) and the source address of the third HB request (src@) are consistent, i.e. identify the same piece of equipment (src@=@1). The trusted server 42 can also check that the proof of integrity recorded in the “NONCE2” field of the HB request is consistent with a proof of integrity determined locally from the verification data stored by the trusted server 42 (as contained by the “CHALLENGE2” field in the response sent by the trusted server). Notably, the trusted server 42 can compute a hash of the verification data (Hash (CHALLENGE2)) and check that it is equal to the hash transmitted in the “NONCE2” field. The trusted server 42 can also check whether the piece of recurrence information contained in the “EPOCH” field is respected.

The DNS client 41 can send a fourth HB request (616) and so on.

For example, the trusted server 42 can modify the verification data at regular intervals for security purposes.

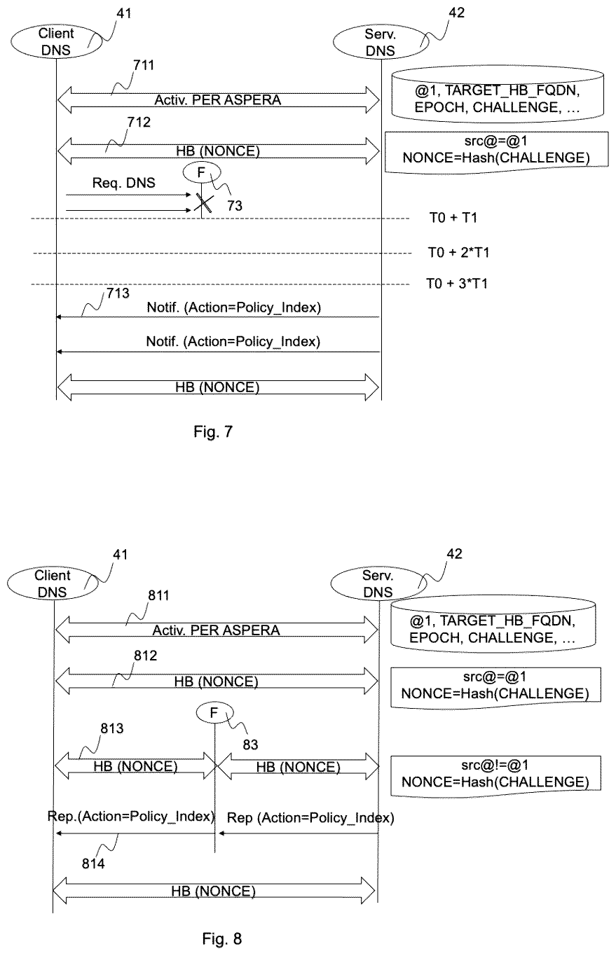

In relation to FIG. 7, the detection of an anomaly when the piece of recurrence information contained in the “EPOCH” field is not respected is now presented.

FIG. 7 illustrates an example of messages exchanged between the DNS client 41 and the trusted server 42. It is considered for example that the DNS client 41 sends an activation request using its address @1, and that the trusted server 42 constructs a response comprising the “TARGET_HB_FQDN”, “EPOCH” and “CHALLENGE” fields (Activ. PER APSERA 711).

According to the example illustrated by FIG. 7, the DNS client 41 sends a first HB request (712) to resolve the domain name indicated in the “TARGET_HB_FQDN” field, comprising a proof of integrity recorded in the “NONCE” field. Upon receipt of the first HB request (712), the trusted server 42 can notably check that the source address of the activation request (@1) and the source address of the first HB request (src@) are consistent. The trusted server 42 can also check that the proof of integrity contained in the “NONCE” field of the HB request is consistent with a proof of integrity determined locally from the verification data contained in the “CHALLENGE” field. The trusted server 42 can also check whether the piece of recurrence information recorded in the “EPOCH” field is respected.

The trusted server 42 notices that it does not receive any HB request at times T0+T1, T0+2T1 and T0+3T1, for example. It therefore detects that the piece of recurrence information contained in the “EPOCH” field (recurrence of the requests with a periodicity T1) is not respected, and sends at least one notification requiring the DNS client 41 to take an action.

For example, one or more notification messages 713 are sent to the address entered in the “CONTACT_URI” field for the DNS client 41, or to the address used by the DNS client 41 to send the activation request.

For example, a notification message can be of type Push HTTPS, Update DNS, etc. Such a message can notably comprise an index corresponding to a given action, for example preconfigured. For example, if a notification message comprises an index equal to 0 (Notif. (Action=0)), the DNS client takes an action such as replacing the active domain name resolution configuration with the configuration of one of the trusted servers. If a notification message comprises an index equal to 1 (Notif. (Action=1)), the DNS client takes an action such as “disabling outgoing communications except for communications to one of the trusted servers for the interface considered”, etc.

The exchange illustrated by FIG. 7 can notably be observed when a malicious DNS server 73 has been configured in the piece of equipment embedding the DNS client 41, and this malicious server 73 blocks all or some of the DNS requests sent by the DNS client 41. The DNS client 41 can take one or more actions upon receipt of the notification message(s), such as reinstalling the trusted DNS configuration, blocking certain communications, etc.

Once the trusted DNS configuration has been reinstalled, for example (reinstallation of the information descriptive of the trusted DNS servers), the trusted server 42 can again receive an HB request.

In relation to FIG. 8, the detection of an anomaly when the source address of an HB request is not consistent with the source address of the activation request is now presented. Similar steps can be implemented when the proof of integrity conveyed by an HB request is not consistent with the proof of integrity determined locally by the trusted server from the verification data known to the trusted server. According to one and/or other of these cases, this typically means that the HB request has been relayed by another potentially malicious DNS server. The trusted server can thus detect that the HB requests (or any other DNS request) sent by the DNS client are intercepted by another DNS server before being routed to the trusted server.

FIG. 8 illustrates an example of messages exchanged between the DNS client 41 and the trusted server 42. It is considered for example that the DNS client 41 sends an activation request using its address @1, and that the trusted server 42 constructs a response comprising the “TARGET_HB_FQDN”, “EPOCH” and “CHALLENGE” fields (Activ. PER APSERA 811).

According to the example illustrated by FIG. 8, the DNS client 41 sends a first HB request (812) to resolve the domain name indicated in the “TARGET_HB_FQDN” field, comprising a proof of integrity recorded in the “NONCE” field. Upon receipt of the first HB request (812), the trusted server 42 can notably check that the source address of the activation request (@1) and the source address of the first HB request (src@) are consistent. The trusted server 42 can also check that the proof of integrity contained in the “NONCE” field of the HB request is consistent with a proof of integrity determined from the verification data recorded in the “CHALLENGE” field. The trusted server 42 can also check whether the piece of recurrence information specified in the “EPOCH” field is respected.

The DNS client 41 then sends a second HB request (813) to resolve the domain name indicated in the “TARGET_HB_FQDN” field, comprising a proof of integrity in the “NONCE” field. However, as illustrated by FIG. 8, this second HB request (813) is intercepted by a server F 83 and relayed to the trusted server 42. Upon receipt of the second HB request (813), the trusted server 42 notices that the source address of the activation request (@1) and the source address of the second HB request (src@) are not consistent (src@!=@1). It therefore detects an anomaly and that the second HB request has probably been relayed by another potentially malicious DNS server (F 83). The trusted server 42 sends at least one notification 814 requiring the DNS client 41 to take an action. For example, one or more notification messages are sent to the address entered in the CONTACT_URI field for the DNS client 41, or to the address used by the DNS client 41 to send the activation request. For example, such a message can be of type DNS response, relayed by the malicious server 83, comprising an index corresponding to a given action, for example preconfigured, to be executed by the DNS client. For example, if a DNS response comprises an index equal to 3 (Rep. (Action=3)), the DNS client takes an action such as “requesting that the identity of the active DNS server be sent”. If a DNS response comprises an index equal to 0 (Rep. (Action =0)), the DNS client takes an action such as replacing the active domain name resolution configuration with the configuration of one of the trusted servers, etc. It should be noted that the trusted server 42 can trigger the execution of several actions for the HB exchanges using an IP address distinct from that used when activating the PER ASPERA service.

The exchange illustrated by FIG. 8 can notably be observed when a malicious DNS server 83 has been configured in the piece of equipment embedding the DNS client 41, and this malicious server 83 behaves like an intermediate DNS relay (“proxy”) that relays the messages between the DNS client 41 and the trusted server 42.

Once the trusted DNS configuration has been reinstalled, for example (reinstallation of the information descriptive of the trusted DNS servers), the trusted server 42 can again receive an HB request.

In a particular embodiment, the trusted server 42 can also include an EDE option, as described in document RFC 8914 “Extended DNS Errors” of October 2020, to inform the DNS client that a DNS error has been observed by the trusted server. Upon receipt of this response, the DNS client can execute the action indicated in the response. As a variant, the action to be executed by a DNS client can be indicated using the WADE option.

To do this, an “A” bit is defined to this end among the “unassigned” bits shown in FIG. 2. When the “A” bit is set to “1”, the action index is entered in the body of the WADE option.

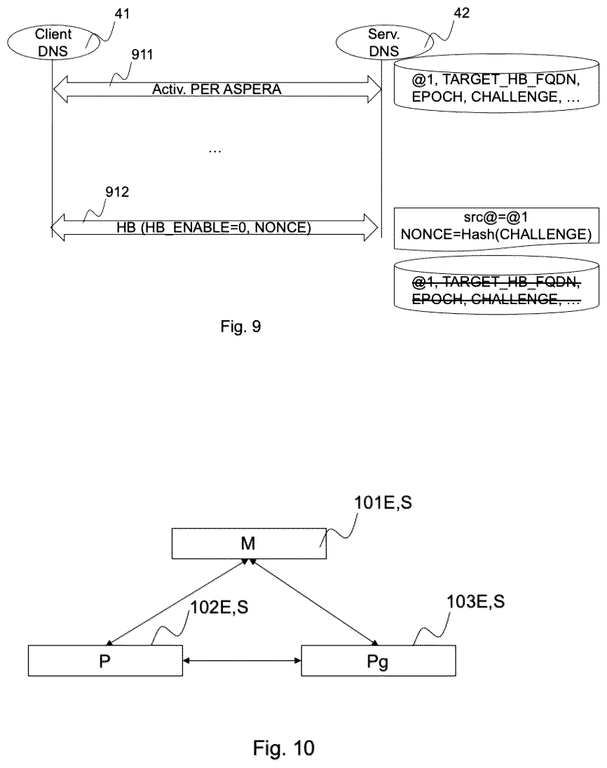

Finally, in relation to FIG. 9, an example of deactivation of the PER ASPERA service for at least one interface of the piece of equipment is presented. It is considered for example that the DNS client 41 sends an activation request using its address @1, and that the trusted server 42 constructs a response comprising the “TARGET_HB_FQDN”, “EPOCH” and “CHALLENGE” fields (Activ. PER APSERA 911).

According to the example illustrated by FIG. 9, when the DNS client 41 wants to deactivate the PER ASPERA service, it sends an HB request (912) to resolve the domain name indicated in the “TARGET_HB_FQDN” field comprising a proof of integrity in the “NONCE” field, computed on the basis of the verification data recorded in the “CHALLENGE” field. To inform the trusted server 42 that the DNS client 41 wants to deactivate the PER ASPERA service, the H bit “HB_ENABLE” is set to “0”.

Upon receipt of such a request, the trusted server 42 checks that there is no anomaly. For example, the trusted server 42 can reject the HB request 912 and return an error message if the proof of integrity contained in the NONCE field of the HB request 912 does not match the proof of integrity computed locally by the trusted server 42 for the verification data recorded in the CHALLENGE field and stored locally for that DNS client.

If it does not detect any anomaly, the trusted server 42 validates the deactivation of the PER ASPERA service.

### Simplified Structure of a Piece of Equipment and a Trusted Server According to One Embodiment

Finally, in relation to FIG. 10, the simplified structure of a piece of equipment, respectively a trusted server, implementing a method for detecting a malicious server according to one embodiment described above is presented.

As illustrated by FIG. 10, such a piece of equipment, respectively trusted server, comprises a memory 101E, respectively 101S, comprising for example a buffer memory, a processing unit 102E, respectively 102S, equipped for example with a processor P, and controlled by the computer program Pg 103E, respectively 103S, implementing the method for detecting a malicious server according to one embodiment described above.

At initialisation, the code instructions of the computer program 103E are for example loaded into a RAM memory before being executed by the processor of the processing unit 102E. The processor of the processing unit 102E implements the steps of the method for detecting a malicious server according to one embodiment described above, according to the instructions of the computer program 103E, to:
transmit, to at least one of said trusted servers, at least one request to activate a domain name resolution verification service,
receive at least one response comprising at least one domain name generated by said trusted server for said at least one interface,
transmit at least one request to resolve said at least one domain name,
if no request to resolve said at least one domain name is received by said trusted server, or if at least one request to resolve said at least one domain name is received by said trusted server but comprises an anomaly, receive at least one notification requiring said piece of equipment to take an action.

At initialisation, the code instructions of the computer program 103S are for example loaded into a RAM memory before being executed by the processor of the processing unit 102S. The processor of the processing unit 102S implements the steps of the method for detecting a malicious server according to one embodiment described above, according to the instructions of the computer program 103S, to:
receive at least one request to activate a domain name resolution verification service from said piece of equipment,
transmit at least one response comprising at least one domain name generated by said trusted server for said at least one interface,
if no request to resolve said at least one domain name is received by said trusted server, or if at least one request to resolve said at least one domain name is received by said trusted server but comprises an anomaly, transmit to said piece of equipment at least one notification requiring it to execute an action.

1. A method of detecting a malicious domain name server, implemented in a piece of equipment configured with at least one trusted domain name server associated with at least one network interface via which the piece of equipment is capable of communicating, the method comprising:
transmitting, to at least one of the trusted servers, at least one request to activate a domain name resolution verification service,
receiving at least one response comprising at least one domain name generated by the trusted server for the at least one interface,
transmitting at least one request to resolve the at least one domain name, and
if no request to resolve said the at least one domain name is received by the trusted server, or if at least one request to resolve the at least one domain name is received by the trusted server but comprises an anomaly, receiving at least one notification requiring the piece of equipment to take an action.

2. The method according to claim 1, wherein the at least one response also comprises verification data generated by the trusted server for the at least one activation request, and in that the at least one request to resolve the at least one domain name comprises a proof of integrity obtained from the verification data.

3. The method according to claim 2, wherein the at least one request to resolve the at least one domain name comprises an indicator requiring generation, by the trusted server, of new verification data.

4. The method according to claim 1, wherein the at least one response and/or the request to resolve the at least one domain name are encrypted.

5. The method according to claim 1, wherein the at least one response also comprises a piece of recurrence information and in that the at least one request to resolve the at least one domain name is transmitted taking into account said the piece of recurrence information.

6. The method according to claim 1, wherein the at least one activation request comprises at least one contact address of the piece of equipment.

7. The method according to claim 1, wherein the information descriptive of the at least one trusted server is stored in a registry maintained by the piece of equipment and whose access is protected.

8. The method according to claim 1, wherein the piece of equipment executes at least one given action upon receipt of a notification requiring it to execute the at least one action, the at least one action belonging to a group comprising:
replacing the active domain name resolution configuration with the configuration of one of the trusted servers,
disabling outgoing communications except for communications to one of the trusted servers,
generating a local notification to inform a user of a modification of the domain name resolution configuration, and
requesting that the active domain name resolution configuration be sent.

9. A method for detecting a malicious domain name server, implemented in a trusted domain name server configured in a piece of equipment and associated with at least one network interface via which the piece of equipment is capable of communicating, the method comprising:
receiving at least one request to activate a domain name resolution verification service from the piece of equipment,
transmitting at least one response comprising at least one domain name generated by the trusted server for the at least one interface, and
if no request to resolve said the at least one domain name is received by the trusted server, or if at least one request to resolve the at least one domain name is received by the trusted server but comprises an anomaly, transmitting to the piece of equipment of at least one notification requiring it to execute an action.

10. The method according to claim 9, wherein an anomaly is detected if the at least one request to resolve the at least one domain name and the at least one activation request do not come from the same piece of equipment.

11. The method according to claim 9, wherein the at least one response also comprises verification data generated by the trusted server for the at least one activation request,
in that the at least one request to resolve the at least one domain name comprises a proof of integrity obtained from the verification data,
and in that an anomaly is detected if the proof of integrity carried by the at least one request to resolve the at least one domain name is not consistent with a proof of integrity obtained locally from the verification data known to the trusted server.

12. The method according to claim 9, wherein the at least one response also comprises a piece of recurrence information of the at least one request to resolve the at least one domain name,
and in that an anomaly is detected if no request to resolve the at least one domain name is received by the trusted server or if the at least one request to resolve the at least one domain name is not consistent with the piece of recurrence information.

13. The method according to claim 9, wherein the at least one action notification is transmitted to at least one contact address of the piece of equipment carried by the activation request or to the address used by the piece of equipment to transmit the activation request.

14. The method according to claim 1, wherein the activation and/or resolution requests use an option according an Extension Mechanisms for DNS (EDNS) mechanism to exchange information between the piece of equipment and the trusted server.

15. A piece of equipment configured with at least one trusted domain name server associated with at least one network interface via which the piece of equipment is capable of communicating, wherein the piece of equipment is configured to:
transmit, to at least one of the trusted servers, at least one request to activate a domain name resolution verification service,
receive at least one response comprising at least one domain name generated by the trusted server for the at least one interface,
transmit at least one request to resolve the at least one domain name, and
if no request to resolve the at least one domain name is received by the trusted server, or if at least one request to resolve the at least one domain name is received by said the trusted server but comprises an anomaly, receive at least one notification requiring the piece of equipment to take an action.

16. A trusted domain name server configured in a piece of equipment and associated with at least one network interface via which the piece of equipment is capable of communicating, wherein the trusted domain name server is configured to:
receive at least one request to activate a domain name resolution verification service from said the piece of equipment,
transmit at least one response comprising at least one domain name generated
if no request to resolve the at least one domain name is received by the trusted server, or if at least one request to resolve the at least one domain name is received by the trusted server but comprises an anomaly, transmit to the piece of equipment at least one notification requiring it to execute an action.

17. The method according to claim 9, wherein the activation and/or resolution requests use an option according to an Extension Mechanisms for DNS (EDNS) mechanism to exchange information between the piece of equipment and the trusted server.
